(19) United States
(12) Patent Application Publication
(10) Pub. No.: US 2016/0352815 A1
(43) Pub. Date: Dec. 1, 2016

(54) Data Distribution Based on Network Information

(71) Applicant: HEWLETT PACKARD ENTERPRISE DEVELOPMENT LP, Houston, TX (US)

(72) Inventor: Mark Brian Mozolewski, Roseville, CA (US)

(21) Appl. No.: 15/117,296

(22) PCT Filed: Apr. 28, 2014
(86) PCT No.: PCT/US2014/035690

§ 371 Date: Aug. 8, 2016

(51) Int. Cl. H04L 29/08; H04L 12/26; H04L 12/751; G06F 9/50; H04L 12/803; H04L 12/755; G06F 17/30; H04L 12/24; H04L 12/721

(52) U.S. Cl. CPC H04L 67/10; H04L 41/12; H04L 41/0803; H04L 43/0882; H04L 45/02; H04L 45/38; H04L 47/125; H04L 45/021; G06F 17/30876; G06F 9/5083

(57) ABSTRACT

In one implementation, the data distribution system comprises a controller communicatively coupled to a network of devices, a topology engine, a stats engine, a data management engine, a flow engine, and a coordinator engine. In another implementation, a medium comprises a set of instructions executable by a processor to maintain network information, maintain a flow table associated with a flow rule, and provide the flow rule to a device of the network. In yet another implementation, a method for distribution of data on a network comprises maintaining network information associated with a set of nodes of a network, identifying a data write request to a data cluster, and modifying a destination of a network flow associated with the data write request based on the network information.

### BACKGROUND

Computer hardware can provide storage for data. Databases and file systems are examples of systems that provide access to stored data. Data within these storage systems can be structured or unstructured. The data storage system can include multiple computers connected together for distribution of the data storage system across hardware. A data storage system can replicate the data at multiple nodes to improve robustness of storage and availability of data.

### BRIEF DESCRIPTION OF THE DRAWINGS

FIGS. 1 and 2 are block diagrams depicting example data distribution systems.

FIG. 3 depicts example environments in which various data distribution systems can be implemented

FIG. 4 depicts example modules used to implement example data distribution systems.

FIGS. 5 and 6 are flow diagrams depicting example methods for distribution of data.

### DETAILED DESCRIPTION

In the following description and figures, some example implementations of data distribution systems and/or methods for distribution of data are described. Some examples of the systems and methods are described specifically for use in a software-defined networking (“SDN”) environment. However it should be noted that examples of providing a distributed storage service described herein can be utilized in a variety of appropriate systems and applications. In particular, a system for distributing data can regulate storage distribution on a system that places data at multiple nodes. Therefore, SDN environments are a potential use of the data distribution system. Thus any reference to SDN-specific elements and/or methods is included to provide context for specific examples described herein.

SDN-compatible networks can provide a service or multiple services to devices or other networks. As used herein, a service is any appropriate supplying of communication, transmissions, software, or any other product, resource, or activity that can be capable of executing on a network of electronic devices. For example, the service related to the present description is supplying data storage. SDN-compatible networks can abstract the hardware of the system from the services being provided. For example, an SDN network can decouple the traffic control decisions from the physical systems that forward network traffic. An SDN network can allow the service to be provided without regard to the underlying physical hardware. For example, a first network device can become latent from becoming overprovisioned (e.g. receiving too many requests) and the SDN network can initiate the service to follow a different traffic flow through a second network device. As another example, the network device or a port of the network device may be malfunctioning and traffic can be rerouted accordingly. In both examples, a customer of the service may not notice a change in service because the SDN controller can make the network routing decisions autonomously.

Distributed data management systems, such as distributed databases and distributed file systems, commonly store data by spreading records or files across multiple machines in a cluster. The data management system determines the placement of the original data and/or replicated data. One method to balance the load of data across servers in a cluster is to place replicated data at random nodes of the organization system to improve availability in the event of a failure. Another method to provided data availability is by maintaining knowledge of data on servers based on a rack identifier, such as encoding the internet protocol (“IP”) address of a node to represent a rack number, and ensuring replicated data exists on physically separated racks. Nodes, even in a random selection or rack aware replication, can become overprovisioned. For example, data could be randomly added to a node that is being routinely accessed for another set of data when other nodes have less commonly accessed data. Thus, a bottleneck in performance can ensue when the status of the network is not considered.

Various examples described below relate to distribution of data based on network information. By factoring in the status of the network and other network information, data can be distributed across the nodes of the network in a dynamic way to balance or customize network traffic load on the network. For example, performance of the data store cluster can be improved when an application to access the data is near the node storing the data and connected via a link that is not overprovisioned. This allows the data organization to adapt to the network in a way congruent with SDN techniques and allows for developers of the data organization systems to focus on organization of the data rather than re-implementing data placement methods.

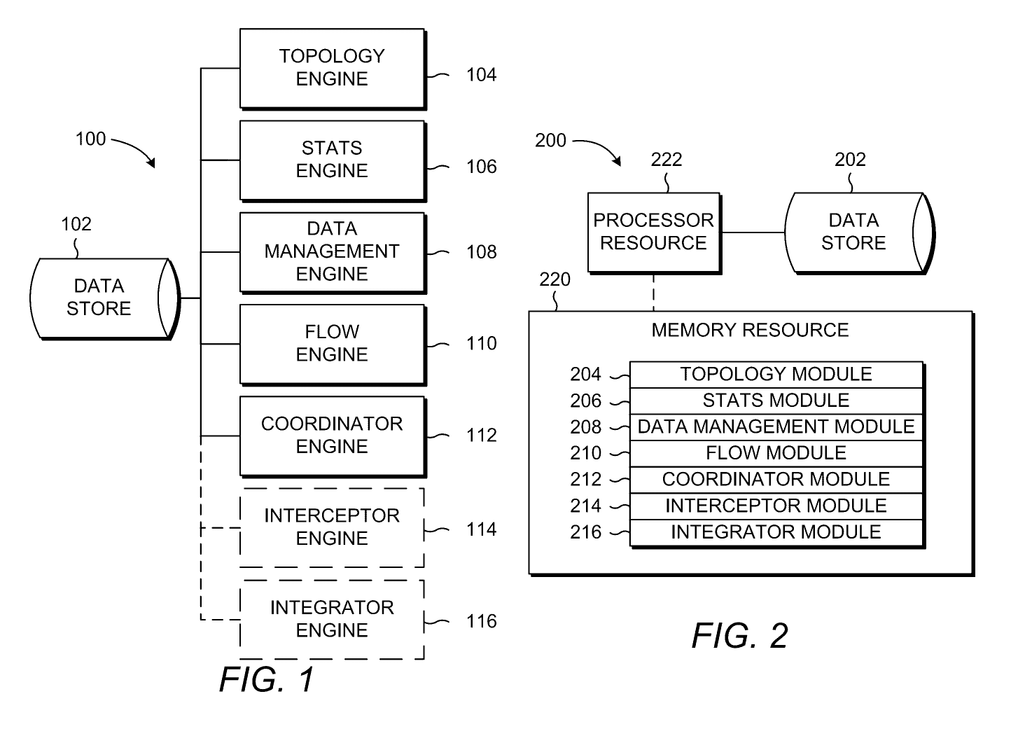

FIGS. 1 and 2 are block diagrams depicting example systems 100 and 200 for data distribution. Referring to FIG. 1, an example system 100 for data distribution can generally comprise a data store 102, a topology engine 104, a stats engine 106, a data management engine 108, a flow engine 110, and a coordinator engine 112. In general, the coordinator engine 112 can coordinate data placement based on a flow identified by the flow engine 110, where the flow is identified based on network information (from the topology engine 104 and the stats engine 106) and database information (from the data management engine 108). The network information can include, for example, a network traffic pattern and utilization history associated with a plurality of nodes of a distributed data management system. The system 100 can also include an interceptor engine 114 and/or an integrator engine 116 to facilitate interaction between the network and the data management system. The engines 104, 106, 108, 110, 112, 114, and 116 of the system 100 can be components of a network. For example, the engines 104, 106, 108, 110, 112, 114 and 116 can be communicatively coupled to a controller that manages the control plane of a network, such as an SDN controller. In that example, the components can be integrated into the controller, integrated into a device of the network, or distributed across the controller, devices of the network, or a combination thereof.

The terms “include,” “have,” and variations thereof, as used herein, mean the same as the term “comprise” or appropriate variation thereof. Furthermore, the term “based on,” as used herein, means “based at least in part on.” Thus, a feature that is described as based on some stimulus can be based only on the stimulus or a combination of stimuli including the stimulus. Furthermore, the term “maintain” (and variations thereof) as used herein means “to create, delete, add, remove, access, update, and/or modify.”

A topology engine 104 represents any combination of circuitry and executable instructions to maintain topology information associated with a topology of the network. Information associated with topology of the network can include a location of a device in the network and a link between that device and another device of the network. As an example, the topology engine 104 can be a component of a network monitor and the information can be kept in a data store, such as data store 102.

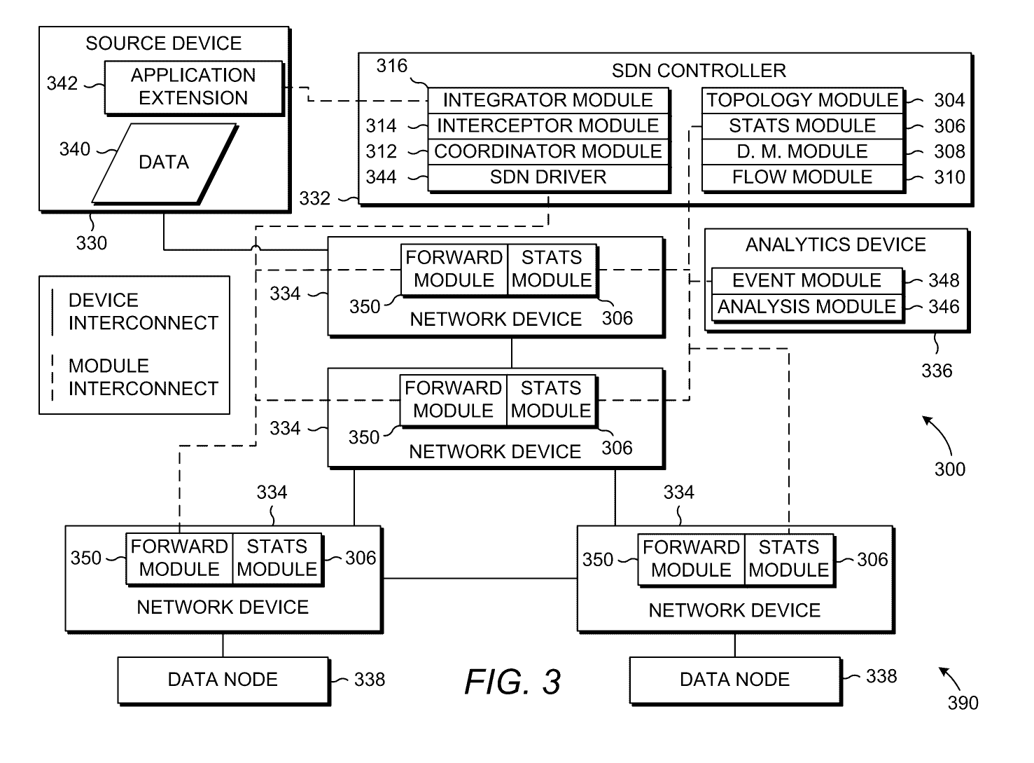

The network can include electronic devices for providing an exchange of information, or a network flow, among the electronic devices, such as a network router or network switch, and can be located on a network path, such as a set of network devices of the network. The network can include a controller to maintain the control plane of the network. A controller may be able to create a network flow and communicate with other controllers and/or devices of the network. For example, the controller can be an SDN controller, such as SDN controller 332 of FIG. 3, and a SDN-enabled network device can receive a flow rule from the SDN controller to forward the set of network traffic based on an action in a flow table through a network path that includes a set of network devices to provide the storage service. The controller can be integrated into a single device or distributed across multiple devices.

A stats engine 106 represents any combination of circuitry and executable instructions to maintain network information. For example, the stats engine 106 can maintain network utilization information associated with utilization of the network, such as a utilization percentage of a particular link of the network. Network utilization of a network segment (e.g. a link or node of the network) can be represented as quantity or other value of the node or link related to the amount of use of the node or link. For example, the link between a first node and a second node may only be utilized to half of the capacity of the link. Network utilization information can include a network traffic pattern, a network link status, a network link speed, and a load history of elements of the network, including the links and the data store nodes of the network. A network traffic pattern can be a history of traffic over the network, such as a record of traffic that has accessed the cluster of data store nodes. A network link status can be a category related to the availability of the link. For example, a link may be down or otherwise unavailable for communication. A network link speed can be the speed of the network link, such as a value based on the bandwidth of the network link. A load history of elements of the network can include prior amounts of use of nodes and/or link associated with the devices of the network and/or the cluster of data store nodes.

The stats engine can be integrated into a device of the network or distributed across multiple devices of the network. As an example, the stats engine 106 can be a component of a network monitor or an analytics device and the information can be kept in a data store, such as data store 102. The stats engine 106 can map the network information to the network based on the topology provided by the topology engine 104. For example, the statistics of the network can be gathered by a monitoring function call (such as a function call of SFLOW industry standard network technology) and identified with the links and nodes of the topological map of the topology engine.

A data management engine 108 represents any combination of circuitry and executable instructions to maintain a cluster of data nodes. The cluster of data nodes can be physical computer hardware, a virtual computing environment, or a combination thereof. For example, the data management engine 108 can be a data management system application installed on server of the network or on multiple servers, such as a cloud network of virtual machines. For another example, the data management engine 108 can be installed on or a component of the SDN controller. As used herein, the term “data management system” includes a management system for any one of a database, a file system, a repository, and the like (such as a combination thereof).

The data management engine 108 can maintain configuration information associated with the cluster of data store nodes. The configuration information can be associated with the organization and management of the data management system. For example, the configuration information can include one of a data block size, a data store utilization level, a data store node physical attribute (such as a hardware or software characteristic), and a replication factor. A “data block” can refer to a section of data and a data block size can be the size of data being copied or available at a data store node. A data store utilization level can be a quantity, percentage, label, category, or other value to denote the amount of use of the data store node and/or the cluster of the data management system. A data store node physical attribute can be a hardware characteristic (such as processor speed or input/output (“I/O”) speed) or a software characteristic (such as virtual memory allocation). A replication factor can be the quantity, percentage, or other value to represent the amount of replication to be performed for a set of data. The data management engine 108 can provide the configuration information to coordinator engine 112 to assist the placement method in identified a particular node to receive data.

The data management engine 108 can maintain a record of the data of the database or file system. For example, the data management engine 108 can maintain a location record of data in a cluster of data store nodes. The data management engine 108 can maintain the record based on a flow table entry. For example, the SDN controller can add an action in the flow table to copy a data block report network message to the data management engine 108. The record can contain utilization information of the cluster of data nodes. The flow engine 110, discussed below, can utilize the cluster utilization information to make a determination regarding which flow and/or destination node is appropriate.

A flow engine 110 represents any combination of circuitry and executable instructions to identify a destination of a flow to direct a data write to a data store node of the cluster based on the network utilization information and the topology information. For example, the flow engine 110 can be a circuit of an SDN controller that can identify a destination of a flow based on the topology of the network and the utilization levels of each link and/or node of the network. The flow engine 110 can receive the topology from the topology engine 104 and the network information from the stats engine 106. The flow engine 110 can utilize the topology and the network information to identify links that are available in the topology. For example, the flow engine 110 can identify multiple link and node combinations and sort them into possible flows through the network.

The flow engine 110, in combination with other engines of the system 100, can identify a flow and a destination that would be appropriate based on the network information. For example, the flow engine 110 can identify possible flows and destinations for data placement in the cluster and then the coordinator engine 112 can rank the flows identified by the network utilization information received from the stats engine 106. For another example, the flow engine 110 can use the stats engine 106 to identify links and/or nodes that are provisioned at a level above a threshold and the flow engine 110 can provide a destination and/or a flow that avoids use of any links and/or nodes that achieve the threshold. The selection of the flow can be made to improve quality and availability of data access (including the data write request) by selecting a flow with a link with lower utilization levels than the average utilization level of the links of the network. For example, the flow engine 110 in the conjunction of the coordinator engine 112. Thresholds can be a minimum value, a maximum value, or based on mathematical calculations such as average link utilization value.

The flow engine 110 can identify the destination of the data write request based on cluster utilization information and the network utilization information. For example, the network utilization information can be used to identify a first node of a cluster and a second node of a cluster as acceptable destinations for the data write and the second node can be selected when the cluster utilization level of the second node is less than the cluster utilization level of the first node. The cluster utilization information can include the amount of use of each node of a cluster and can be maintained by the data management engine 108.

A coordinator engine 112 represents any combination of circuitry and executable instructions to maintain a flow rule based on an identified flow. The coordinator engine 112 can maintain and provide the flow rule associated with a flow identified by the flow engine 110 to a controller which can modify the control plane accordingly. The coordinator engine 112 can assist in selection of the appropriate flow. For example, the flow engine 110 can provide a list of flows and/or destinations and the coordinator engine 112 can select an appropriate flow and/or destination based on the network information provided by the stats engine 106 and create a flow modification instruction associated with the selected flow. For another example, the coordinator engine 112 can be integrated into an SDN controller with logic to derive and install flow modification request on network switches via the services of the SDN controller. In that example, the redirection of cluster data writes can be sent to network segments having utilization levels below a sufficient threshold in a fashion congruent with network routing performed by SDN controllers to improve availability of services.

The coordinator engine 112 can utilize information associated with the data management system as kept by the data management engine 108. For example, the coordinator engine 112 can select between a first destination and a second destination provided by the flow engine 110 based on the utilization level of each destination.

The coordinator engine 112 can perform control plane modifications during and after the time utilized to identify a flow and forward the flow rule to devices of the network accordingly. For example, the coordinator engine 112 can provide a timeout function once the flow table updates to include the flow for the data write request, implement an intermediary action (e.g. a write to the modified destination of the data write request) while the flow table is updated with the results of the identification performed by the flow engine 110, and revert to the original destination of the data write request after the period of the timeout function is reached.

An interceptor engine 114 represents any combination of circuitry and executable instructions to intercept a set of network traffic to modify the destination address. For example, the interceptor engine 114 can match or otherwise perform an action to recognize that a set of network traffic is a request to perform a data write to the data management system and, in response to the match, apply the flow identified by the flow engine 110.

An integrator engine 116 represents any combination of circuitry and executable instructions to respond to a request for a destination based on the identification made by the flow engine 110. For example, the integrator engine 116 can receive a request for a flow identification from a source and the integrator engine 116 can instruct the coordinator engine 112 to send a flow identification to the source. The flow identification and include an identified destination and/or flow. The integrator engine 116 can allow for a network application to retrieve a destination address associated with a data store node of the cluster prior to sending the data write request to the data management system.

The data store 102 can contain information utilized by the engines 104, 106, 108, 110, 112, 114, and 116. For example, the data store 102 can store the topology of the network, historical records of network stats and access patterns, and data node records.

FIG. 2 depicts an example data distribution system 200, which can be implemented on a memory resource 220 operatively coupled to a processor resource 222. The processor resource 222 can be operatively coupled to a data store 202. The data store 202 can be the same as the data store 102 of FIG. 1.

The memory resource 220 can contain a set of instructions that are executable by the processor resource 222. The set of instructions can implement the system 200 when executed by the processor resource 222. The set of instructions stored on the memory resource 220 can be represented as a topology module 204, a stats module 206, a data management module 208, a flow module 210, a coordinator module 212, an interceptor module 214, and an integrator module 216. The processor resource 222 can carry out a set of instructions to execute the modules 204, 206, 208, 210, 212, 214, 216, and/or any other appropriate operations among and/or associated with the modules of the system 200. For example, the processor resource 222 can carry out a set of instructions to maintain network information, maintain a flow table associated with a flow rule to forward traffic associated with a distributed data management system to a node of a plurality of nodes based on the network information, and provide the flow rule to a device of a network. The topology module 204, the stats module 206, the data management module 208, the flow module 210, the coordinator module 212, the interceptor module 214, and the integrator module 216 represent program instructions that when executed function as the topology engine 104, the stats engine 106, the data management engine 108, the flow engine 110, the coordinator engine 112, the interceptor module 114, and the integrator module 116 of FIG. 1, respectively.

The processor resource 222 can be one or multiple central processing units (“CPUs”) capable of retrieving instructions from the memory resource 220 and executing those instructions. Such multiple CPUs can be integrated in a single device or distributed across devices. The processor resource 222 can process the instructions serially, concurrently, or in partial concurrence.

The memory resource 220 and the data store 202 represent a medium to store data utilized and/or produced by the system 200. The medium can be any non-transitory medium or combination of non-transitory mediums able to electronically store data, such as modules of the system 200 and/or data used by the system 200. For example, the medium can be a storage medium, which is distinct from a transitory transmission medium such as a signal. The medium can be machine readable, such as computer readable. The memory resource 220 can be said to store program instructions that when executed by the processor resource 222 implements the system 200 of FIG. 2. The memory resource 220 can be integrated in the same device as the processor resource 222 or it can be separate but accessible to that device and the processor resource 222. The memory resource 220 can be distributed across devices. The memory resource 220 and the data store 202 can represent the same physical medium or separate physical mediums. The data of the data store 202 can include representations of data and/or information mentioned herein.

In the discussion herein, the engines 104, 106, 108, 110, 112, 114, and 116 of FIG. 1 and the modules 204, 206, 208, 210, 212, 214, and 216 of FIG. 2 have been described as a combination of circuitry and executable instructions. Such components can be implemented in a number of fashions. Looking at FIG. 2, the executable instructions can be processor executable instructions, such as program instructions, stored on the memory resource 220, which is a tangible, non-transitory computer readable storage medium, and the circuitry can be electronic circuitry, such as processor resource 222, for executing those instructions.

In one example, the executable instructions can be part of an installation package that when installed can be executed by the processor resource 222 to implement the system 200. In that example, the memory resource 220 can be a portable medium such as a compact disc, a digital video disc, a flash drive, or memory maintained by a computer device, such as a source device 330 of FIG. 3, from which the installation package can be downloaded and installed. In another example, the executable instructions can be part of an application or applications already installed. The memory resource 220 can include integrated memory such as a hard drive, a solid state drive, random access memory (“RAM”), read only memory (“ROM”), electrically erasable programmable ROM (“EEPROM”), flash memory, or the like.

FIG. 3 depicts example environments in which various example data distribution systems can be implemented. The example environment 390 is shown to include an example system 300 for data distribution. The system 300 (described herein with respect to FIGS. 1 and 2) can represent generally any combination of circuitry and executable instructions to distribute data to a plurality of data store nodes. The system 300 can include a topology engine 304, a stats module 306, a data management module 308 (labeled as “D. M. Module” in FIG. 3), a flow module 310, a coordinator module 312, an interceptor module 314, and an integrator module 316 that are the same as the topology module 204, the stats module 206, the data management module 208, the flow module 210, the coordinator module 212, the interceptor module 214, and the integrator module 216 of FIG. 2, respectively, and the associated descriptions are not repeated for brevity. As shown in FIG. 3, the modules 304, 306, 308, 310, 312, 314, and 316 can be integrated into a controller, such as SDN controller 332. The modules 304, 306, 308, 310, 312, 314, and 316 can be integrated via circuitry or as installed instructions into a memory resource of the SDN controller 332, such as SDN applications installed on a computer readable storage medium.

The example environment 390 can include a source device 330, an SDN controller 332, network devices 334, and data nodes 338. The SDN controller can be connected to network devices 334. The network devices 334 represent generally any compute device to respond to a network request received from a source device 330. The network devices 334 can include components for network monitoring (e.g. stats modules 306) and traffic forwarding (e.g. forward modules 350).

The source device 330 represents generally any compute device with a browser or other application to communicate a network request and receive and/or process the corresponding responses. The source device 330 can contain the data 340 to be stored in the cluster of data nodes 338. The source device 330 can include an application extension 342 to communicate with the system 300, such as via the integrator module 316. The source device 330 can be located on the same or a separate network than the network devices 334. The devices 330, 332, 334, 336, and 338 can be physical devices, virtual devices, or a combination thereof. For example, the environment 390 can be a cloud computing environment where the data nodes 338 are virtual instances of resources made available by the network devices 334.

The example environment 390 can also include an analytics device 336. The analytics device 336 can make utilization computations based on the statistics of the network retrieved by the stats modules 306. The analytics device 336 can maintain and otherwise identify the status information of the network. For example, the event module 348 can capture an event of the network to trigger a utilization analysis of the network by the analysis module 346. The analysis module 346 can identify and compare the statistics of the network segments related to the event. An event of the network can be any appropriate network communications, such as a data write request, failure of a network device, and other network communications. For example, the event module 348 can receive a simple network message protocol (“SNMP”) message and the analysis module 346 can perform a network utilization update based on the data contained in the SNMP message.

The devices 330, 332, 334, 336, and 338 can be connected via links, such as device interconnects or module interconnects represented in FIG. 3. The links can be physical, virtual, or a combination thereof. A link represents generally one of a cable, wireless connection, fiber optic connection, or remote connections via a telecommunications link, an infrared link, a radio frequency link, or any other connectors of systems that provide electronic communication. A link can include, at least in part, intranet, the Internet, or a combination of both. A link can also include intermediate proxies, routers, switches, load balancers, and the like.

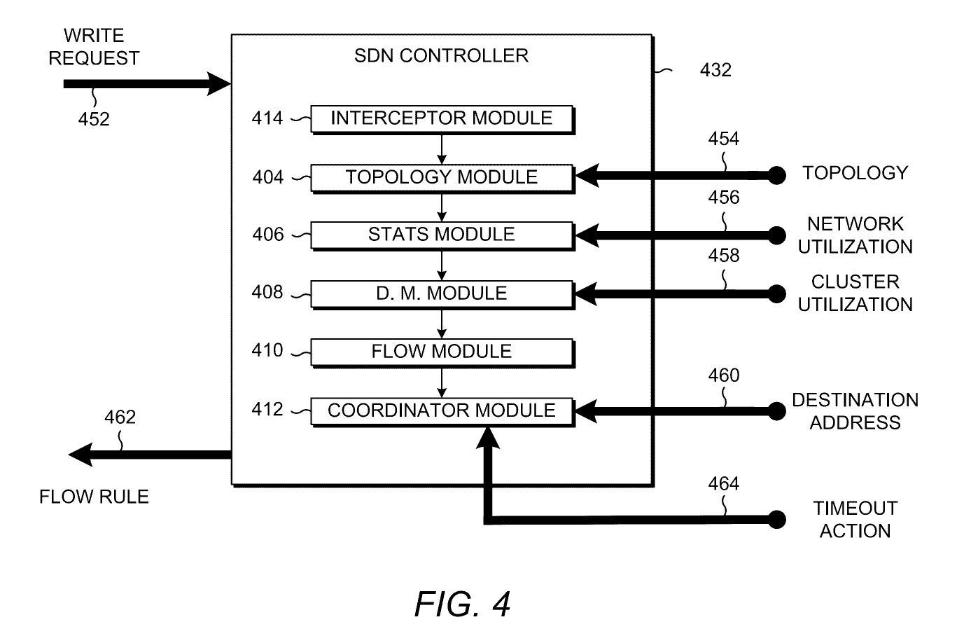

Referring to FIGS. 1-3, the engines 104, 106, 108, 110, 112, 114, and 116 of FIG. 1, and/or the modules 204, 206, 208, 210, 212, 214, and 216 of FIG. 2 can be distributed across devices 330, 332, 334, 336, and 338, or a combination thereof. The engine and/or modules can complete or assist completion of operations performed in describing another engine and/or module. For example, the coordinator module 312 of FIG. 3 can request, complete, or perform method or operations described with the coordinator module 212 of FIG. 2 as well as the topology module 204, the stats module 206, the data management module 208, and the flow module 210 of FIG. 2. The modules of the system 300 can perform the example methods described in connection with FIGS. 4-6.

FIG. 4 depicts example modules used to implement example data distribution systems. Referring to FIG. 4, the example modules of FIG. 4 can be implemented on an SDN controller 432 and generally include a topology module 404, a stats module 406, a data management module 408 (labeled as “D. M. Module” in FIG. 4), a flow module 410, a coordinator module 412, and an interceptor module 414 that can be the same as the topology module 204, the stats module 206, the data management module 208, the flow module 210, the coordinator module 212, the interceptor module 214, and the integrator module 216 of FIG. 2, respectively, and the associated descriptions are not repeated for brevity.

When a write request 452 to a data management system is sent over the network, the interceptor module 414 can intercept the write request. For example, the write request 452 can have a destination address that is associated with the data management system that does not have a match in the flow table, and thus the request for a flow can be intercepted by the SDN controller 432 to identify a modified destination address 460 based on the status of the network.

Once the SDN controller 432 has intercepted the write request 452, the SDN controller 432 can retrieve network information to identify a data node to send the write request 452. For example, the SDN controller 432 can use the topology module 404 to retrieve the topology 454 of the network and use the stats module 406 to retrieve network utilization information 456 of the network. In the example embodiment shown in FIG. 4, the SDN controller 432 can also retrieve cluster utilization information 458 from the data management module 408.

The flow module 410 can utilize the information of the network retrieved by the topology module 404, the stats module 406, and/or the data management module 408 when identifying a destination address 460 of a plurality of nodes of the data management system. For example, the flow module 410 can identify a flow table action to modify an original destination address of the write request 452 to a modified destination address 460 associated with the node identified based on network information, such as information that a network segment has a utilization level that achieves a predetermined threshold. Utilizing network information in determining data placement allows the write request 452 to be mapped to a cluster node of the network based on network load and direct incoming data writes to an underutilized cluster or an area of the network that is utilized less than another segment of the network.

The coordinator module 412 can identify a flow rule 462 based on the destination address 460 identified by the flow module 410. The flow rule 462 can then be forwarded to devices of the network from the SDN controller 432. The coordinator module 412 can set a flow rule 462 to provide a flow table action to a set of network devices that directs a packet associated with the write request 452 to an output port directed to a destination switch of the modified destination address 460. For example, a 1 gigabyte set of data can be sent in 64 kilobyte segments where the first segment can be intercepted by the SDN controller 432 to identify a destination address 460 of an appropriate data node and the devices of the network can be updated with a flow rule 462 to allow the following 64 kilobyte segments to follow the identified flow to the destination address 460. Once the network is updated with the flow rule 462 to direct the write request 452 to the destination address 460, any subsequent packets of the write request 452 can be routed to the destination address 460.

The SDN controller 432 can provide a timeout function 464 with the flow rule 462 when the flow table is to update with the flow table actions associated with the modified destination address 460. The timeout function 464 can set a condition for a duration of time to maintain the flow table with the flow table action. For example, the timeout function 464 can be a hard timeout that provides the flow rule 462 for a time period (e.g. a set value of seconds) and then removes the associated flow table action from the flow table after the time period. For another example, the timeout function 464 can be an idle timeout that removes the associated flow action based on whether the flow is matched (e.g. whether the IP address is matched) within a time period. The timeout action 464 can update the flow table to write to the original destination address of the data write request 452 after the condition is satisfied. Without a timeout function 464, a burst of writes can over utilize the identified network segment before the SDN controller 432 is able to update the flow table.

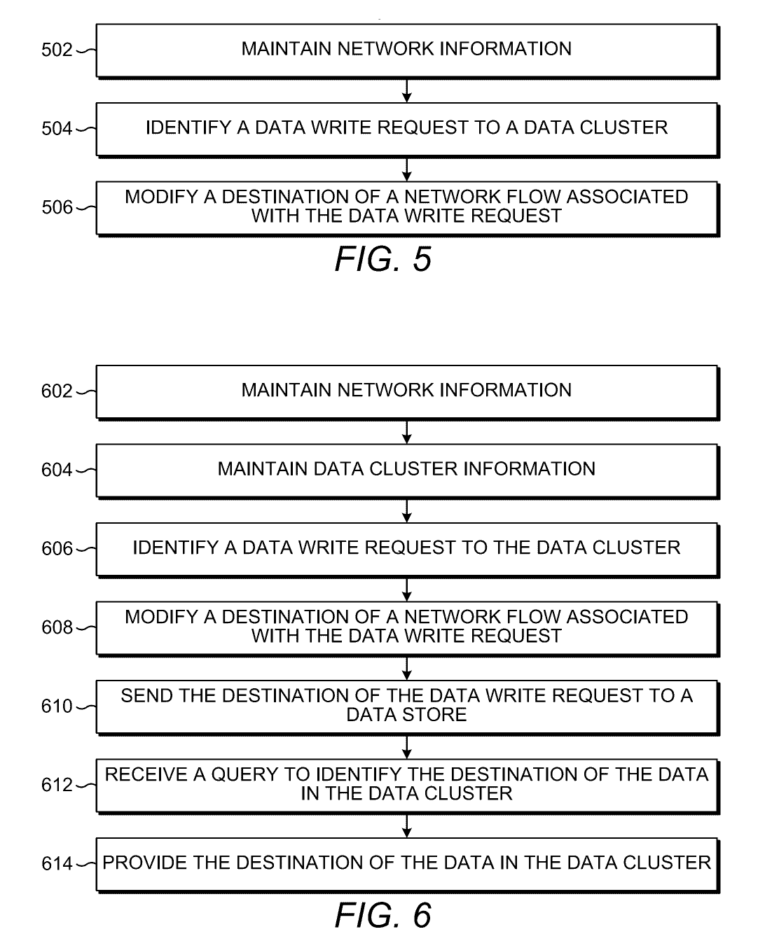

FIGS. 5 and 6 are flow diagrams depicting example methods of data distribution. Referring to FIG. 5, example methods for distributing data on a network can generally comprise maintaining network information, identifying a data write request, and modifying the destination of the data write request.

At block 502, network information is maintained. Network information can be retrieved via a monitor of the network and/or network management messages (e.g. SNMP messages) from a network device to a controller. Network information can include status information and utilization information. Status information can include topological information (e.g. location and interconnections of a set of nodes), availability information (e.g. whether a node is operational, malfunctioning, or inoperable—also known as “up” or “down”), and attribute information (e.g. link speed). Utilization information can include utilization levels of a segment (e.g. a network link or a network node), load history of a segment, and a network traffic pattern. The network information can be related to network segments used by the data management system. For example, the utilization information can include utilization statistics of a set of links associated with a set of nodes that belong to the data management system. For another example, the network information can include a network traffic pattern of data access requests to a data management system and utilization history associated with a data cluster (e.g. a plurality of data store nodes) of the data management system.

At block 504, a data write request to a data cluster is identified. For example, a data write request can be made over the network and the data write request can be recognized as a request to a data management system (e.g. a file system or database) having a distributed infrastructure (e.g. multiple nodes and/or multiple clusters for storage). Once intercepted, the original (or first) destination address of the data write request can be modified to a second destination address based on the network information maintained at block 502.

At block 506, a destination of a network flow associated with the data write request is modified. For example, the first destination address can be modified to a second destination address associated with a lower utilized segment of the network than the segment associated with the first destination address. Thus, the network information can influence data placement and balance traffic across the network as well as improve read performance by placing data in an area of the network that is historically utilized less often.

As a particular example, the method shown in FIG. 5 can be used with the HADOOP distributed file system (HDFS) for storage and large-scale processing of data sets on clusters of commodity hardware. HDFS utilizes a master-salve architecture in which the master NameNode tracks which slave DataNodes hold the primary and replicated data blocks for a file. NameNode generally recommends where to place the data based on its known data block reports. The data write request produced by NameNode can be intercepted (e.g. identified as a data write request to data cluster) and the data can be placed elsewhere based on the network information (e.g. a second DataNode that is less utilized than the first DataNode recommended by NameNode.) The DataNode reports the data additions (as well as modifications and removals) to the NameNode. In this manner, NameNode's operation is not affected while the network traffic can be improved by placing the data at a DataNode that exists on a segment that has more utilization potential.

FIG. 6 includes blocks similar to blocks of FIG. 5 and provides additional blocks and details. In particular, FIG. 6 depicts additional blocks and details generally regarding maintaining data cluster information, sending the destination to a data store, and providing the destination based on a query for the destination of the data write request. Blocks 602, 606, and 608 are the same as blocks 502, 504, and 506 of FIG. 5 and, for brevity, their respective descriptions have not been repeated.

At block 604, data cluster information is maintained. For example, the data cluster utilization information can be maintained to assist the determination of a data node, as usually the data nodes of a cluster having various utilization levels within the cluster.

At block 610, the destination of the write request is sent to a data store. The data store can be used to maintain a location record of the data stored by the data cluster of the data management system. For example, when the modified destination of the original write request is added to a flow table, a record associating the set of data and the destination of the data in the data management system can be created and maintained. The location record of the data placement can be maintained based on a network event. Maintaining the location record can assist data management systems that track data placement in a proactive manner to update data placement tracking records of the data management system. Thus, when a query to identify the destination of the data in the data cluster is received at block 612, the data management system can reply with the destination of the data in the data cluster in block 614. This method can simplify distributed application development and maintenance by implementing the distribution via the network and provides for centralize intelligence and control of data placement as well as automatically add protection against a single point of failure.

Although the flow diagrams of FIGS. 5-7 illustrate specific orders of execution, the order of execution can differ from that which is illustrated. For example, the order of execution of the blocks can be scrambled relative to the order shown. Also, the blocks shown in succession can be executed concurrently or with partial concurrence. All such variations are within the scope of the present description.

The present description has been shown and described with reference to the foregoing examples. It is understood, however, that other forms, details, and examples can be made without departing from the spirit and scope of the following claims.

What is claimed is:

1. A data distribution system comprising:
a controller communicatively coupled to a network of devices, the controller capable of distributing a flow rule to a device of the network;
a topology engine communicatively coupled to the controller, the topology engine to maintain topology information associated with a topology of the network;
a stats engine communicatively coupled to the controller, the stats engine to maintain network utilization information associated with network utilization;
a data management engine communicatively coupled to the controller, the data management engine to maintain a cluster of data store nodes;
a flow engine communicatively coupled to the controller, the flow engine to identify a destination of a flow to direct a data write to a data store node of the cluster based on the network utilization information and the topology information; and
a coordinator engine communicatively coupled to the controller, the coordinator engine to maintain the flow rule based on the destination identified by the flow engine.

2. The data distribution system of claim 1, comprising:
an interceptor engine coupled to the controller, the interceptor engine to:
recognize a set of network traffic is a request to perform the data write; and
apply the flow identified by the flow engine to the set of network traffic.

3. The data distribution system of claim 1, wherein
the topology information comprises location information of a location of the data store node and a link to the data store node; and
network utilization information comprises one of a network traffic pattern, a network link status, a network link speed, and a load history of the data store node.

4. The data distribution system of claim 1, wherein the data management engine is to:
maintain configuration information associated with the cluster of data store nodes, the configuration information to include one of a data block size, a data store utilization level, a data store node physical attribute, and a replication factor.

5. The data distribution system of claim 1, wherein:
the coordinator engine is to modify a flow table to copy a data block report network message to the data management engine;
the data management engine is to maintain a location record of data in the cluster of data store nodes; and
the flow engine is to identify the destination of the data write request based on cluster utilization information and the network utilization information.

6. The data distribution system of claim 1, comprising:
an integrator engine communicatively coupled to the controller, the integrator engine to:
receive a request for a flow identification from a source; and
send the flow identification from the coordinator engine to the source.

7. A machine readable medium comprising a set of instructions executable by a processor resource to:
maintain network information, the network information to include a network traffic pattern and a utilization history associated with a plurality of nodes of a distributed database;
maintain a flow table associated with a flow rule, the flow rule to forward traffic associated with a distributed database to a node of the plurality of nodes based on the network information; and
provide the flow rule to a device of a network.

8. The medium of claim 7, wherein the set of instructions is to:
identify a flow table instruction to direct a data write request to the node when the node has a utilization level lower than an average utilization level of the plurality of nodes.

9. The medium of claim 8, wherein the set of instructions is to:
set a flow table action to modify a first destination address of the data write request to a second destination address, the second destination address associated with the node identified based on a network segment identified that is to achieve the utilization level; and
direct a write request packet associated with the data write request to an output port directed to a destination switch of the second destination address.

10. The medium of claim 9, wherein the set of instructions is to:
provide a timeout function when the flow table is to update with the second destination address, the timeout function to set a condition for a duration of the flow table action; and
set a timeout action to update the flow table to write to the first destination address of the data write request after the condition is satisfied.

11. A method for distribution of data on a network comprising:
maintaining network information associated with a set of nodes of a network;
identifying a data write request to a data cluster, the data cluster comprising a plurality of storage nodes; and
modifying a destination of a network flow associated with the data write request based on the network information.

12. The method of claim 11, wherein the network information includes:
a topology of the set of nodes; and
a set of utilization information associated with the set of nodes, the set of utilization information to include utilization statistics of a set of links associated with the set of nodes.

13. The method of claim 11, comprising:
providing the destination based on the network information prior to sending the data write request.

14. The method of claim 11, comprising:
sending the destination to a data store for maintaining a location record of data stored by the data cluster; and
maintaining the location record based on a network event.

15. The method of claim 12, comprising:
receiving a query request to identify the destination of the data in the data cluster; and
providing the destination of the data in the data cluster.
